(19) United States
(12) Patent Application Publication
(10) Pub. No.: US 2004/0194145 A1
(43) Pub. Date: Sep. 30, 2004

(54) Leveraging PC processing power to handle CPU intensive tasks

(75) Inventors: Ludovic E. Douillet, Elk Grove, CA (US); Donald Molaro, Sunnyvale, CA (US)

Correspondence Address: Jonathan O. Owens, HAVERSTOCK & OWENS LLP, 162 North Wolfe Road, Sunnyvale, CA, 94086, US

(73) Assignees: Sony Corporation; Sony Electronics Inc.

(21) Appl. No.: 10/402,598

(22) Filed: Mar. 27, 2003

(51) Int. Cl. H04N 7/173

(52) U.S. Cl. 725/110; 725/131

(57) ABSTRACT

A set top box (STB), an interactive television and a personal computer (PC) are coupled together as part of a network, preferably a home network. A processing request is received by the STB, wherein the processing request is preferably a request to manipulate a corresponding data. The corresponding data is preferably content stored within the home network. In response to the processing request, the STB first determines if a processing capability of the STB is sufficient to perform the processing request. If the STB includes sufficient processing capability, then the STB processes the request. If not, then the STB determines if the PC has sufficient processing capability to process the request. If the PC includes sufficient processing capability, then the STB issues a command to the PC to perform the processing request. Once the PC receives the command from the STB, the PC performs the processing request on the corresponding data and sends the processed data from the PC to the STB.

### FIELD OF THE INVENTION

The present invention relates to the field of application system resource management. More particularly, the present invention relates to the field of leveraging external processing power to handle processing intensive tasks requested by a set-top box.

### BACKGROUND OF THE INVENTION

In many hardware devices, system resources such as memory and processing power are scaled to meet current device application requirements and/or to reduce costs. Such devices typically include a number of applications which are stored in a secondary storage device within the device. When an application is first used after the device is powered on, the application is loaded from the secondary storage device to random access memory (RAM). This process requires system resources and time to perform. System resource management is a primary concern in devices comprising limited system resources. In particular, television set-top boxes and related interactive televisions include limited system resources.

Set-top boxes are often used as intermediary devices between a content source, such as a personal computer or a remote cable televison provider, and a display device, such as a television. Often, set-top boxes include multiple applications including content menus and display parameter settings. If the set-top box with limited system resources is capable of receiving new or upgraded applications, such enhancements may require greater system resources than the set-top box was originally designed to handle. Overtaxing existing system resources may lead to excessive delays and/or system failures.

With the proliferation of the personal computer (PC) and it's ability to store, retrieve, manipulate, process, and display multimedia data, people are looking to televisions to perform similar functionality. As a result, user expectations related to the functionality of the television are changing from that of a strictly passive viewing device to an interactive multimedia device. Users are turning to their televisions as a user interface to a broader interactive experience. Since users are turning to their televisions to access and use similar functionality that they would traditionally receive from the PC, the user expects the same level of performance as when using the PC. Unfortunately, most conventional interactive televisions and/or set-top boxes designed to provide basic functionality are also designed with the minimum system resources necessary to perform such functions. Further, the basic applications are not as robust and expansive as many of the applications found on personal computers.

### SUMMARY OF THE INVENTION

Embodiments of the present invention include a set top box (STB), an interactive television and a personal computer (PC) coupled together as part of a network, preferably a home network. The home network is preferably coupled to remote content providers via a cable/satellite service provider network or the Internet. Content can be received and displayed in real time or can be stored within the STB or the PC. A processing request is received by the STB, wherein the processing request is preferably a request to manipulate a corresponding data. The corresponding data is preferably content stored within the home network. In response to the processing request, the STB first determines if a processing capability of the STB is sufficient to perform the processing request. If the STB includes sufficient processing capability, then the STB processes the request. If not, then the STB preferably determines if the PC has sufficient processing capability to process the request. If the PC includes sufficient processing capability, then the STB issues a command to the PC to perform the processing request. Once the PC receives the command from the STB and retrieves the corresponding data, the PC performs the processing request on the corresponding data and sends the processed data from the PC to the STB.

In one aspect of the present invention, a method of leveraging external system resources includes receiving a data processing request by a local device, determining if a local processor includes a processing capability necessary to perform the data processing request, transferring the data processing request to an external processor if the local processor is not capable of processing the data processing request, performing the data processing request by the external processor, and returning a result of the performed data processing request to the local device. The necessary processing capability can be determined by measuring a required time frame to complete the data processing request by the local processor and matching the required time frame to a predetermined processing time limit. The data processing request can be sent in response to a user selecting an application provided by the local device. The data processing request can be related to a processing intensive application. The local device can be a set-top box. The external processor can reside within a personal computer. The set-top box can be coupled to the personal computer via a home network. The method can include determining if the external processor is capable of processing the data processing request prior to transferring the data processing request to the external processor. The data processing request can include a corresponding data to be processed. Performing the data processing request can comprise processing the corresponding data. The corresponding data to be processed can be transferred to the external processor from a remote content source. The corresponding data to be processed can be transferred to the external processor from the remote source via the local device. The remote content source can comprise a cable service provider, a satellite service provider, or a content source coupled to the internet. The corresponding data to be processed can be transferred to the external processor from a local storage device coupled to the external processor. The local device and the external processor can form a master-slave relationship such that the local device is the master and the external processor is the slave.

In another aspect of the present invention, a method of leveraging external system resources includes receiving a data processing request by a local device, determining if a local processor includes a processing capability necessary to perform the data processing request, transferring the data processing request and a corresponding data to be processed to an external processor if the local processor is not capable of processing the data processing request, performing the data processing request by the external processor, thereby processing the corresponding data, and transferring the processed data from the external processor to the local device. The necessary processing capability can be determined by measuring a required time frame to complete the data processing request by the local processor and matching the required time frame to a predetermined processing time limit. The data processing request can be sent in response to a user selecting an application provided by the local device. The data processing request can be related to a processing intensive application. The local device can comprise a set-top box. The external processor can reside within a personal computer. The set-top box can be coupled to the personal computer via a home network. The method can include determining if the external processor is capable of processing the data processing request prior to transferring the data processing request to the external processor. The corresponding data to be processed can be transferred to the external processor from a remote content source. The corresponding data to be processed can be transferred to the external processor from the remote source via the local device. The remote content source can comprise a cable service provider, a satellite service provider, or a content source coupled to the intemet. The corresponding data to be processed can be transferred to the external processor from a local storage device coupled to the external processor. The local device and the external processor can form a master-slave relationship such that the local device is the master and the external processor is the slave.

In yet another aspect of the present invention, a device includes a processor, and an input/output interface coupled to the processor such that in operation the processor receives a data processing request and determines if a processing capability of the processor is sufficient to process the data processing request, and if the processing capability is insufficient then the data processing request is transferred via the input/output interface to an external processor, where the data processing request is performed and a result of the performed data processing request is returned to the processor via the input/output interface. It is preferably determined that the processing capability of the processor is sufficient by measuring a required time frame to complete the data processing request by the processor and matching the required time frame to a predetermined processing time limit. The device can include a user interface coupled to the processor such that the data processing request is sent in response to a user selecting an application provided by the device. The device can include a memory coupled to the processor, wherein the memory includes the application selected by the user. The data processing request can be related to a processing intensive application. The device can comprise a set-top box. The external processor can reside within a personal computer. The set-top box can be coupled to the personal computer via a home network. The processor can transfer the data processing request to the external processor after the processor determines if a processing capability of the external processor is sufficient to process the data processing request. The data processing request can include a corresponding data to be processed. The corresponding data to be processed can be transferred to the external processor from a remote source via the device. The remote content source can comprise a cable service provider, a satellite service provider, or a content source coupled to the internet. The processor and the external processor can form a master-slave relationship such that the processor is the master and the external processor is the slave.

In still yet another aspect of the present invention, a set-top box includes a processor, and an input/output interface coupled to the processor such that in operation the processor receives a data processing request and determines if a processing capability of the processor is sufficient to process the data processing request, and if the processing capability is insufficient then the data processing request is transferred via the input/output interface to an external processor, where the data processing request is performed and a result of the performed data processing request is returned to the processor via the input/output interface. It is preferably determined that the processing capability of the processor is sufficient by measuring a required time frame to complete the data processing request by the processor and matching the required time frame to a predetermined processing time limit. The set-top box can include a user interface coupled to the processor such that the data processing request is sent in response to a user selecting an application provided by the set-top box. The set-top box can include a memory coupled to the processor, wherein the memory includes the application selected by the user. The data processing request can be related to a processing intensive application. The external processor can reside within a personal computer. The set-top box can be coupled to the personal computer via a home network. The processor can transfer the data processing request to the external processor after the processor determines if a processing capability of the external processor is sufficient to process the data processing request. The data processing request can include a corresponding data to be processed. The corresponding data to be processed can be transferred to the external processor from a remote source via the set-top box. The remote content source can comprise a cable service provider, a satellite service provider, or a content source coupled to the internet. The processor and the external processor can form a master-slave relationship such that the processor is the master and the external processor is the slave.

In another aspect of the present invention, a network of devices includes a remote computing device including an external processor, an application device coupled to the remote computing device, the application device including a processor and an input/output interface coupled to the processor such that in operation the processor receives a data processing request and determines if a processing capability of the processor is sufficient to process the data processing request, and if the processing capability is insufficient then the data processing request is transferred via the input/output interface to the external processor, where the data processing request is performed and a result of the performed data processing request is returned to the processor via the input/output interface. It is preferably determined that the processing capability of the processor is sufficient by measuring a required time frame to complete the data processing request by the processor and matching the required time frame to a predetermined processing time limit. The application device can include a user interface coupled to the processor such that the data processing request is sent in response to a user selecting an application provided by the application device. The application device can include a memory coupled to the processor, wherein the memory includes the application selected by the user. The data processing request can be related to a processing intensive application. The application device can comprise a set-top box. The external processor can reside within a personal computer. The set-top box can be coupled to the personal computer via a home network. The processor can transfer the data processing request to the external processor after the processor determines if a processing capability of the external processor is sufficient to process the data processing request. The data processing request can include a corresponding data to be processed. The corresponding data to be processed can be transferred to the external processor from a remote source. The corresponding data to be processed can be transferred to the external processor from the remote source via the application device. The remote content source can comprise a cable service provider, a satellite service provider, or a content source coupled to the internet. The processor and the external processor can form a master-slave relationship such that the processor is the master and the external processor is the slave. The network of devices can include a display device coupled to the application device wherein the result of the performed data processing request is sent from the application device to the display device for display. The display device can be an interactive television.

In yet another aspect of the present invention, a network of devices includes a personal computer including an external processor, a set-top box coupled to the personal computer, the set-top box including a processor and an input/output interface coupled to the processor such that in operation the processor receives a data processing request and determines if a processing capability of the processor is sufficient to process the data processing request, and if the processing capability is insufficient then the data processing request is transferred via the input/output interface to the external processor, where the data processing request is performed and a result of the performed data processing request is returned to the processor via the input/output interface. It is preferably determined that the processing capability of the processor is sufficient by measuring a required time frame to complete the data processing request by the processor and matching the required time frame to a predetermined processing time limit. The set-top box can include a user interface coupled to the processor such that the data processing request is sent in response to a user selecting an application provided by the set-top box. The set-top box can include a memory coupled to the processor, wherein the memory includes the application selected by the user. The data processing request can be related to a processing intensive application. The set-top box can be coupled to the personal computer via a home network. The processor can transfer the data processing request to the external processor after the processor determines if a processing capability of the external processor is sufficient to process the data processing request. The data processing request can include a corresponding data to be processed. The corresponding data to be processed can be transferred to the external processor from a remote source. The corresponding data to be processed can be transferred to the external processor from the remote source via the set-top box. The remote content source can comprise a cable service provider, a satellite service provider, or a content source coupled to the internet. The processor and the external processor can form a master-slave relationship such that the processor is the master and the external processor is the slave. The network of devices can include an interactive television coupled to the set-top box wherein the result of the performed data processing request is sent from the set-top box to the interactive television for display.

### BRIEF DESCRIPTION OF THE DRAWINGS

FIG. 1 illustrates an exemplary network of devices.

FIG. 2 illustrates an exemplary block diagram of the internal components of the computer illustrated in FIG. 1.

FIG. 3 illustrates an exemplary set-top box according to the present invention.

FIG. 4 illustrates a preferred process of leveraging external processing power according to the preferred embodiment of the present invention.

### DETAILED DESCRIPTION OF THE EMBODIMENTS

Embodiments of the present invention enable the formation of a master-slave relationship between an interactive television set top box (STB) and a personal computer (PC) such that the STB can request the PC handle processing-intensive operations. The STB is preferably coupled to an interactive television and the personal computer (PC) via a home network. Preferably, the home network is coupled to a remote content provider via a cable/satellite service provider network or the Internet. Content is provided to the home network to be displayed in real time or to be stored, preferably on a mass storage of the PC or on a memory within the STB. In operation, the STB receives a processing request from a user to process a corresponding data. Preferably, the corresponding data comprises a video file, a graphics file, an audio file, an image file and/or an audio/video file. The STB first determines if there is sufficient processing capability within the STB to process the processing request. If the STB includes sufficient processing capability, then the STB processes the request. If not, then the STB determines if the PC has sufficient processing capability to process the request. If the PC includes sufficient processing capability, then the STB issues a command to the PC to perform the processing request. Alternatively, if the STB is not capable of handling the processing request, then the processing request is automatically sent by the STB to the PC for processing. Once the PC receives the command from the STB, the PC performs the processing request on the corresponding data. Preferably, the corresponding data is loaded into a system memory of the PC in order to be processed. Once processed according to the processing request, the processed data is sent from the PC to the STB.

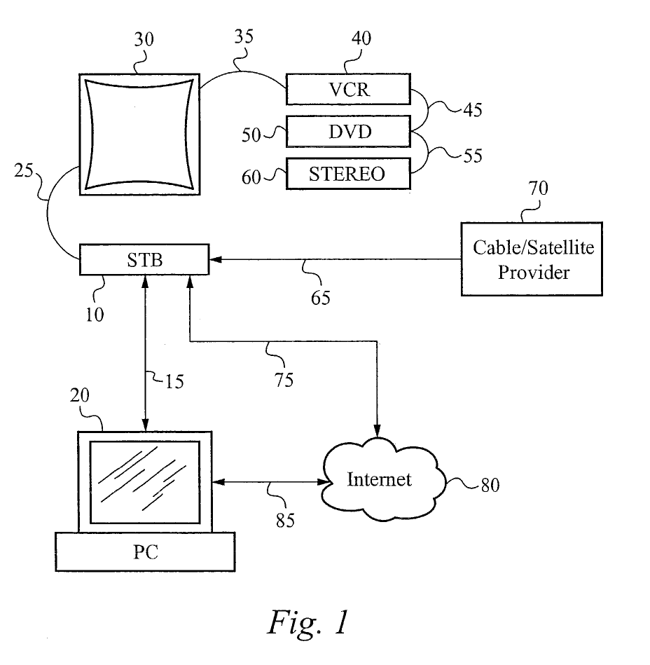

FIG. 1 illustrates an exemplary network of devices including a stereo receiver 60, a DVD player 50, a video cassette recorder (VCR) 40, a set top box (STB) 10, a television 30, a computer 20, a cable/satellite provider 70 and the Internet 80 connected together by network connections 15, 25, 35, 45, 55, 65, 75, and 85. The network connection 55 couples the stereo receiver 60 to the DVD player 50. The network connection 45 couples the DVD player 50 to the VCR 40. The network connection 35 couples the VCR 40 to the television 30. The network connection 25 couples the television 30 to the STB 10. The network connection 15 couples the STB 10 to the PC 20. The network connection 65 couples the STB 10 to the cable/satellite provider 70. The network connection 75 couples the STB 10 to the Internet 80. The network connection 85 couples the PC 20 to the Internet 80.

The configuration illustrated in FIG. 1 is exemplary only. It should be apparent that an audio/video network could include many different combinations of components. It should also be apparent that network connections 15, 25, 35, 45 and 55 can be of any conventional type, including but not limited to ethernet, IEEE 1394-2000, or wireless. Network connections 65, 75 and 85 can be of any conventional type sufficient to provide a connection to a remote content source, including but not limited to the public switched telephone network, cable network, and satellite network. Preferably, each of the STB 10 and the PC 20 include a processor with a known processing capability, and the processors form a master-slave relationship in which the STB processor is the master and the PC processor is the slave to implement the distributed processing of the present invention.

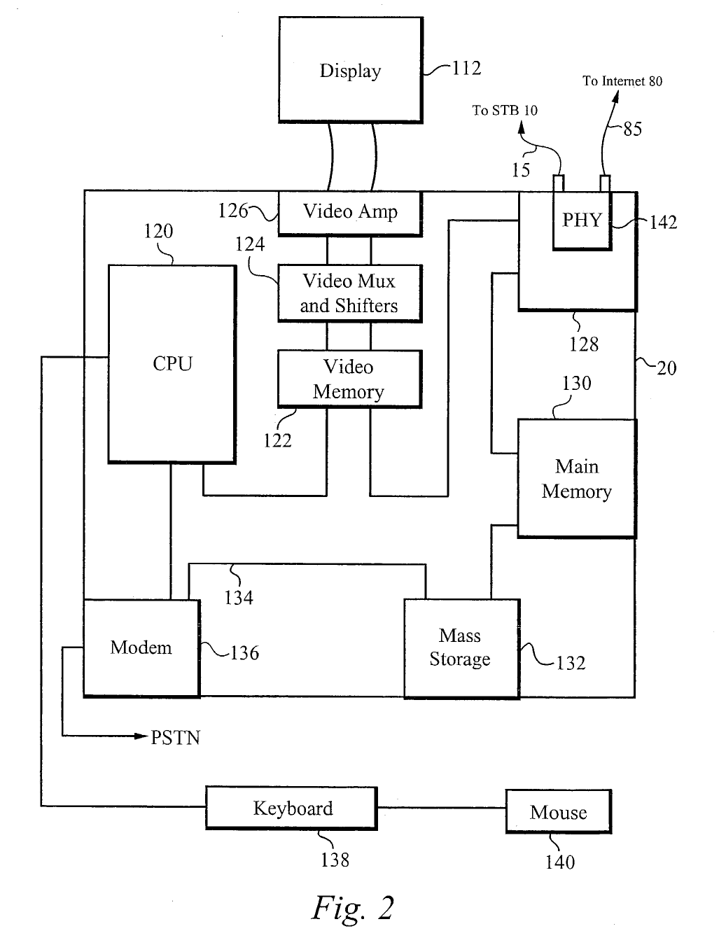

An exemplary block diagram of the internal components of the computer 20 is illustrated in FIG. 2. Within the drawings, the same elements as to FIGS. 1-3 are labeled with the same numbers. The computer 20 includes a central processor unit (CPU) 120, a main memory 130, a video memory 122, a mass storage device 132, a modem 136, and a network interface circuit 128, all coupled together by a conventional bidirectional system bus 134. The interface circuit 128 includes the physical interface circuit 142 for sending and receiving communications over the network connection. The physical interface circuit 142 is coupled to the STB 10 and the Internet 80 via network connections 15 and 85, respectively. In the preferred embodiment of the present invention, the interface circuit 128 is implemented on a network interface card within the computer 20. However, it should be apparent to those skilled in the art that the interface circuit 128 can be implemented within the computer 20 in any other appropriate manner, including building the interface circuit onto the motherboard itself. It should also be apparent to those skilled in the art that more or less network connections can be provided by the interface circuit 128 than the two network connections illustrated in FIG. 2. The interface circuit 128 provides a preferred high-speed connection to the Internet 80. Alternatively, the modem 136 provides a dial-up connection via the public switched telephone network (PSTN) to access the Internet 80. The mass storage device 132 may include both fixed and removable media using any one or more of magnetic, optical or magneto-optical storage technology or any other available mass storage technology. The system bus 134 contains an address bus for addressing any portion of the memory 122 and 130. The system bus 134 also includes a data bus for transferring data between and among the CPU 120, the main memory 130, the video memory 122, the mass storage device 132, the modem 136, and the interface circuit 128.

The computer 20 is also coupled to a number of peripheral input and output devices including the keyboard 138, the mouse 140 and the associated display 112. The keyboard 138 is coupled to the CPU 120 for allowing a user to input data and control commands into the computer 20. A conventional mouse 140 is coupled to the keyboard 138 for manipulating graphic images on the display 112 as a cursor control device.

A port of the video memory 122 is coupled to a video multiplex and shifter circuit 124, which in turn is coupled to a video amplifier 126. The video amplifier 126 drives the display 112. The video multiplex and shifter circuitry 124 and the video amplifier 126 convert pixel data stored in the video memory 122 to raster signals suitable for use by the display 112.

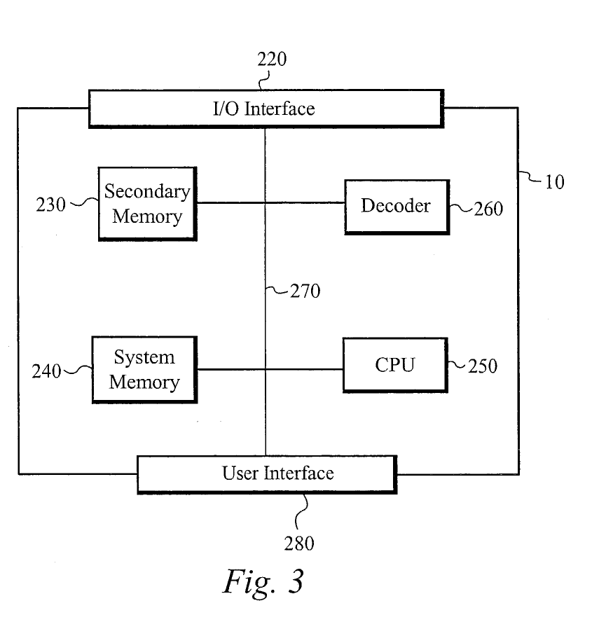

FIG. 3 illustrates an exemplary set-top box according to the present invention. The set-top box 10 preferably controls the transmission of multimedia from a local storage device, such as a personal computer (PC), to a television or from a remote content provider, such as a cable television provider, to the television. The set-top box 10 includes an input/output (I/O) interface 220, a secondary memory 230, a system memory 240, a central processing unit (CPU) 250, a user interface 280, and a decoder 260 all coupled together via a bi-directional bus 270. The I/O interface 220 preferably couples the set-top box 10 to a content source such as the cable/satellite provider 70 (FIG. 1) or the Internet 80 (FIG. 1) for receiving multimedia data, to the television 30 (FIG. 1) or other display device for displaying the multimedia data received from the content source, and to the PC 20 (FIG. 1). The I/O interface 220 is also coupled to a conventional network, such as the Internet 80 or communication links to the cable/satellite provider 70, to receive periodic software upgrades including new versions of operating software and new or upgraded applications. The I/O interface 220 also sends and receives control signals to and from the user interface 280 and the television 30, the PC 20 and remote computing devices coupled to the conventional network. The user interface 280 preferably comprises a keypad and display, as is well known in the art. Alternatively, the user interface 280 comprises any conventional user interface.

The secondary memory 230 stores the software used to enable operation of the set-top box 10 along with a plurality of applications. Exemplary applications include, but are not limited to a menu of available content such as an on-screen television guide, and display parameter settings such as color, tint, and brightness. Additional applications can include front end interfaces used to send and receive control commands to a remote application, as will be explained in detail below. Preferably, the secondary memory 230 is flash memory. Alternatively, any conventional type of memory can be used. Preferably, the system memory 240 includes random access memory (RAM). The system memory 240 can also include additional buffers, registers, and cache according to specific design implementations. Multimedia data received by the set-top box 10 is preferably encrypted to prevent unauthorized access and use, and the decoder 260 decrypts the multimedia data according to access authorization provided by the CPU 250.

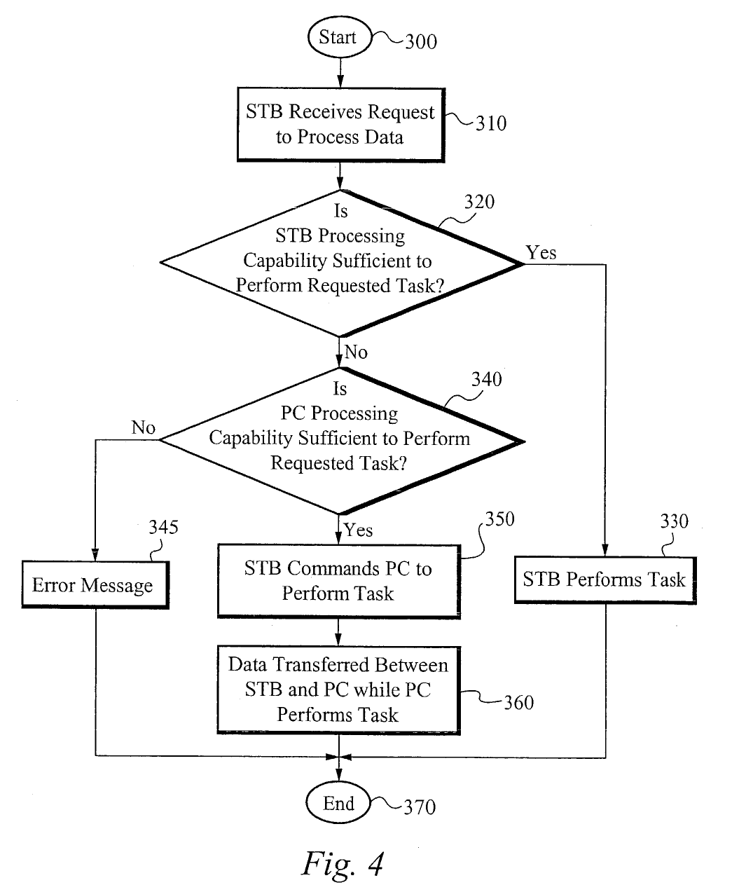

FIG. 4 illustrates a preferred process of leveraging external processing power for processing intensive tasks according to the preferred embodiment of the present invention. The preferred process starts at the step 300. At the step 310, a set top box (STB) receives a processing request. Preferably, the processing request includes a reference to corresponding data to be processed. The corresponding data can be stored on a secondary memory within the STB, can be a stream of data received by the STB from a remote content provider, can be stored on a remote storage device, and/or can be a stream of data received by a remote processing device from a remote content provider. Preferably, the remote processing device is a personal computer coupled to the STB. At the step 320, it is determined if the STB includes sufficient processing capability to process the processing request. Preferably, sufficient processing capability is determined by measuring a required time frame to complete the processing request by the STB and matching the required time frame to a predetermined processing time limit. It should be clear to those skilled in the art that other alternative means for determining sufficient processing capability can be used.

If it is determined at the step 320 that the STB does include sufficient processing capability to process the processing request, then at the step 330 the STB executes the processing request. After the processing request is performed at the step 330, the process ends at the step 370. If it is determined at the step 320 that the STB does not include sufficient processing capability to process the processing request, then at the step 340 it is determined if a personal computer (PC) coupled to the STB includes sufficient processing capability to process the processing request. Preferably, the step of determining if the PC includes sufficient processing capability is performed by the STB. Alternatively, the PC determines if the PC includes sufficient processing capability to process the processing request, and the PC returns the determination to the STB. If it is determined at the step 340 that the PC does not include sufficient processing capability to process the processing request, then at the step 345 an error message is displayed which indicates that the desired processing request can not be performed. After the error message is displayed at the step 345, the process ends at the step 370.

If it is determined at the step 340 that the PC does include sufficient processing capability to process the processing request, then at the step 350 the STB commands the PC to execute the processing request. At the step 360, data corresponding to the processing request is transferred between the STB and the PC as necessary to perform the processing request. As a result, the corresponding data is processed according to the processing request by the PC, and the resulting processed data is sent to the STB. The processed data can then be used by the STB or can be transferred by the STB to another network device, such as a television. After the processed data is received by the STB at the step 360, the process ends at the step 370.

In an alternative embodiment, if it is determined at the steps 320 and 340 that neither the STB nor the PC include sufficient processing capability to process the processing request, then an additional step can be included which determines a current processing capability of each of the STB and the PC, and the processing request is directed to the device with the highest current processing capability. In yet another alternative embodiment, if it is determined at the step 320 that the STB does not include sufficient processing capability to process the processing request, then the processing request is automatically sent to the PC without determining if the PC includes sufficient processing capability to process the processing request.

A set top box is preferably coupled to an interactive television and a personal computer (PC) via a home network. Preferably, the home network is coupled to a remote content provider. The remote content provider can be a cable or satellite service provider coupled to the home network via conventional networking means , The home network can also be coupled to an external network such as the Internet in order to access additional remote content providers. Content is received over the home network as multimedia data, which is directed through the STB to be displayed on the interactive television or the PC. The received content can also be stored, preferably on a mass storage of the PC or on a memory within the STB. A user can use the interactive television/STB to initiate a processing request. The processing request is preferably associated with one or more applications included within the STB. The STB can use the network connection not only as a means for receiving content, but also to use the PC to manipulate multimedia data from a current condition to a new condition. On occasion, this manipulation is a function that the STB is not capable of performing within a reasonable period of time.

In operation, the STB receives the processing request. Preferably, the processing request is sent by the user of the STB, and the processing request is a request to process a corresponding data. For example, a user requests to edit an image using an image editor, or the user requests to video edit a stored video file. Preferably, the corresponding data includes a multimedia file which can include, but is not limited to, a video file, a graphics file, an audio file, an image file or an audio/video file. The STB first determines if there is sufficient processing capability within the STB to process the processing request. If the STB includes sufficient processing capability, then the STB processes the request. If not, then the STB preferably determines if the PC has sufficient processing capability to process the request. If the PC includes sufficient processing capability, then the STB issues a command to the PC to perform the processing request. Included with the command is corresponding data to be processed. Alternatively, the command includes reference to a storage location of the corresponding data. Once the PC receives the command from the STB, the PC performs the processing request. Preferably, the corresponding data is loaded into a system memory of the PC in order to be processed. Once processed according to the processing request, the processed data is sent from the PC to the STB. In this manner, the STB/interactive television is used as a display point to provide a user interface and as a command point to provide commands related to processing requests made through the user interface. The actual processing associated with the processing request and the memory required for processing the corresponding data is handled by the PC. By allowing the formation of a master-slave relationship between the STB and the PC, the STB can request that the PC handle processing-intensive operations.

The present invention has been described in terms of specific embodiments incorporating details to facilitate the understanding of the principles of construction and operation of the invention. Such references, herein, to specific embodiments and details thereof are not intended to limit the scope of the claims appended hereto. It will be apparent to those skilled in the art that modifications can be made in the embodiments chosen for illustration without departing from the spirit and scope of the invention. Specifically, it will be apparent to one of ordinary skill in the art that while the preferred embodiment of the present invention is used with set-top boxes, the present invention can also be implemented on any other appropriate system resource limited device.

What is claimed is:

1. A method of leveraging external system resources, the method comprising:
a. receiving a data processing request by a local device;
b. determining if a local processor includes a processing capability necessary to perform the data processing request;
c. transferring the data processing request to an external processor if the local processor is not capable of processing the data processing request;
d. performing the data processing request by the external processor; and
e. returning a result of the performed data processing request to the local device.

2. The method of claim 1 wherein the necessary processing capability is determined by measuring a required time frame to complete the data processing request by the local processor and matching the required time frame to a predetermined processing time limit.

3. The method of claim 1 wherein the data processing request is sent in response to a user selecting an application provided by the local device.

4. The method of claim 1 wherein the data processing request is related to a processing intensive application.

5. The method of claim 1 wherein the local device comprises a set-top box.

6. The method of claim 5 wherein the external processor resides within a personal computer.

7. The method of claim 6 wherein the set-top box is coupled to the personal computer via a home network.

8. The method of claim 1 further comprising determining if the external processor is capable of processing the data processing request prior to transferring the data processing request to the external processor.

9. The method of claim 1 wherein the data processing request includes a corresponding data to be processed.

10. The method of claim 9 wherein performing the data processing request comprises processing the corresponding data.

11. The method of claim 1 wherein the corresponding data to be processed is transferred to the external processor from a remote content source.

12. The method of claim 11 wherein the corresponding data to be processed is transferred to the external processor from the remote source via the local device.

13. The method of claim 12 wherein the remote content source comprises a cable service provider, a satellite service provider, or a content source coupled to the internet.

14. The method of claim 1 wherein the corresponding data to be processed is transferred to the external processor from a local storage device coupled to the external processor.

15. The method of claim 1 wherein the local device and the external processor form a master-slave relationship such that the local device is the master and the external processor is the slave.

16. A method of leveraging external system resources, the method comprising:
a. receiving a data processing request by a local device;
b. determining if a local processor includes a processing capability necessary to perform the data processing request;
c. transferring the data processing request and a corresponding data to be processed to an external processor if the local processor is not capable of processing the data processing request;
d. performing the data processing request by the external processor, thereby processing the corresponding data; and
e. transferring the processed data from the external processor to the local device.

17. The method of claim 16 wherein the necessary processing capability is determined by measuring a required time frame to complete the data processing request by the local processor and matching the required time frame to a predetermined processing time limit.

18. The method of claim 16 wherein the data processing request is sent in response to a user selecting an application provided by the local device.

19. The method of claim 16 wherein the data processing request is related to a processing intensive application.

20. The method of claim 16 wherein the local device comprises a set-top box.

21. The method of claim 20 wherein the external processor resides within a personal computer .

22. The method of claim 21 wherein the set-top box is coupled to the personal computer via a home network.

23. The method of claim 16 further comprising determining if the external processor is capable of processing the data processing request prior to transferring the data processing request to the external processor.

24. The method of claim 16 wherein the corresponding data to be processed is transferred to the external processor from a remote content source.

25. The method of claim 24 wherein the corresponding data to be processed is transferred to the external processor from the remote source via the local device.

26. The method of claim 25 wherein the remote content source comprises a cable service provider, a satellite service provider, or a content source coupled to the internet.

27. The method of claim 16 wherein the corresponding data to be processed is transferred to the external processor from a local storage device coupled to the external processor.

28. The method of claim 16 wherein the local device and the external processor form a master-slave relationship such that the local device is the master and the external processor is the slave.

29. A device comprising:
a. a processor; and
b. an input/output interface coupled to the processor such that in operation the processor receives a data processing request and determines if a processing capability of the processor is sufficient to process the data processing request, and if the processing capability is insufficient then the data processing request is transferred via the input/output interface to an external processor, where the data processing request is performed and a result of the performed data processing request is returned to the processor via the input/output interface.

30. The device of claim 29 wherein it is determined that the processing capability of the processor is sufficient by measuring a required time frame to complete the data processing request by the processor and matching the required time frame to a predetermined processing time limit.

31. The device of claim 30 further comprising a user interface couple to the processor such that the data processing request is sent in response to a user selecting an application provided by the device.

32. The device of claim 31 further comprising a memory coupled to the processor, wherein the memory includes the application selected by the user.

33. The device of claim 29 wherein the data processing request is related to a processing intensive application.

34. The device of claim 29 wherein the device comprises a set-top box.

35. The device of claim 34 wherein the external processor resides within a personal computer.

36. The device of claim 35 wherein the set-top box is coupled to the personal computer via a home network.

37. The device of claim 29 wherein the processor transfers the data processing request to the external processor after the processor determines if a processing capability of the external processor is sufficient to process the data processing request.

38. The device of claim 29 wherein the data processing request includes a corresponding data to be processed.

39. The device of claim 38 wherein the corresponding data to be processed is transferred to the external processor from a remote source via the device.

40. The device of claim 39 wherein the remote content source comprises a cable service provider, a satellite service provider, or a content source coupled to the internet.

41. The device of claim 29 wherein the processor and the external processor form a master-slave relationship such that the processor is the master and the external processor is the slave.

42. A set-top box comprising:
a. a processor; and
b. an input/output interface coupled to the processor such that in operation the processor receives a data processing request and determines if a processing capability of the processor is sufficient to process the data processing request, and if the processing capability is insufficient then the data processing request is transferred via the input/output interface to an external processor, where the data processing request is performed and a result of the performed data processing request is returned to the processor via the input/output interface.

43. The set-top box of claim 42 wherein it is determined that the processing capability of the processor is sufficient by measuring a required time frame to complete the data processing request by the processor and matching the required time frame to a predetermined processing time limit.

44. The set-top box of claim 42 further comprising a user interface coupled to the processor such that the data processing request is sent in response to a user selecting an application provided by the set-top box.

45. The set-top box of claim 44 further comprising a memory coupled to the processor, wherein the memory includes the application selected by the user.

46. The set-top box of claim 42 wherein the data processing request is related to a processing intensive application.

47. The set-top box of claim 42 wherein the external processor resides within a personal computer.

48. The set-top box of claim 48 wherein the set-top box is coupled to the personal computer via a home network.

49. The set-top box of claim 42 wherein the processor transfers the data processing request to the external processor after the processor determines if a processing capability of the external processor is sufficient to process the data processing request.

50. The set-top box of claim 42 wherein the data processing request includes a corresponding data to be processed.

51. The set-top box of claim 50 wherein the corresponding data to be processed is transferred to the external processor from a remote source via the set-top box.

52. The set-top box of claim 51 wherein the remote content source comprises a cable service provider, a satellite service provider, or a content source coupled to the internet.

53. The set-top box of claim 42 wherein the processor and the external processor form a master-slave relationship such that the processor is the master and the external processor is the slave.

54. A network of devices comprising:
a. a remote computing device including an external processor;
b. an application device coupled to the remote computing device, the application device including a processor and an input/output interface coupled to the processor such that in operation the processor receives a data processing request and determines if a processing capability of the processor is sufficient to process the data processing request, and if the processing capability is insufficient then the data processing request is transferred via the input/output interface to the external processor, where the data processing request is performed and a result of the performed data processing request is returned to the processor via the input/output interface.

55. The network of devices of claim 54 wherein it is determined that the processing capability of the processor is sufficient by measuring a required time frame to complete the data processing request by the processor and matching the required time frame to a predetermined processing time limit.

56. The network of devices of claim 54 wherein the application device further comprises a user interface coupled to the processor such that the data processing request is sent in response to a user selecting an application provided by the application device.

57. The network of devices of claim 56 wherein the application device further comprises a memory coupled to the processor, wherein the memory includes the application selected by the user.

58. The network of devices of claim 54 wherein the data processing request is related to a processing intensive application.

59. The network of devices of claim 54 wherein the application device comprises a set-top box.

60. The network of devices of claim 59 wherein the external processor resides within a personal computer.

61. The network of devices of claim 60 wherein the set-top box is coupled to the personal computer via a home network.

62. The network of devices of claim 54 wherein the processor transfers the data processing request to the external processor after the processor determines if a processing capability of the external processor is sufficient to process the data processing request.

63. The network of devices of claim 54 wherein the data processing request includes a corresponding data to be processed.

64. The network of devices of claim 63 wherein the corresponding data to be processed is transferred to the external processor from a remote source.

65. The network of devices of claim 64 wherein the corresponding data to be processed is transferred to the external processor from the remote source via the application device.

66. The network of devices of claim 65 wherein the remote content source comprises a cable service provider, a satellite service provider, or a content source coupled to the internet.

67. The network of devices of claim 54 wherein the processor and the external processor form a master-slave relationship such that the processor is the master and the external processor is the slave.

68. The network of devices of claim 54 further comprising a display device coupled to the application device wherein the result of the performed data processing request is sent from the application device to the display device for display.

69. The network of devices of claim 68 wherein the display device is an interactive television.

70. A network of devices comprising:
a. a personal computer including an external processor;
b. a set-top box coupled to the personal computer, the set-top box including a processor and an input/output interface coupled to the processor such that in operation the processor receives a data processing request and determines if a processing capability of the processor is sufficient to process the data processing request, and if the processing capability is insufficient then the data processing request is transferred via the input/output interface to the external processor, where the data processing request is performed and a result of the performed data processing request is returned to the processor via the input/output interface.

71. The network of devices of claim 70 wherein it is determined that the processing capability of the processor is sufficient by measuring a required time fi lame to complete the data processing request by the processor and matching the required time frame to a predetermined processing time limit.

72. The network of devices of claim 70 wherein the set-top box further comprises a user interface coupled to the processor such that the data processing request is sent in response to a user selecting an application provided by the set-top box.

73. The network of devices of claim 72 wherein the set-top box further comprises a memory coupled to the processor, wherein the memory includes the application selected by the user.

74. The network of devices of claim 70 wherein the data processing request is related to a processing intensive application.

75. The network of devices of claim 74 wherein the set-top box is coupled to the personal computer via a home network.

76. The network of devices of claim 70 wherein the processor transfers the data processing request to the external processor after the processor determines if a processing capability of the external processor is sufficient to process the data processing request.

77. The network of devices of claim 70 wherein the data processing request includes a corresponding data to be processed.

78. The network of devices of claim 77 wherein the corresponding data to be processed is transferred to the external processor from a remote source.

79. The network of devices of claim 78 wherein the corresponding data to be processed is transferred to the external processor from the remote source via the set-top box.

80. The network of devices of claim 79 wherein the remote content source comprises a cable service provider, a satellite service provider, or a content source coupled to the internet.

81. The network of devices of claim 70 wherein the processor and the external processor form a master-slave relationship such that the processor is the master and the external processor is the slave.

82. The network of devices of claim 70 further comprising an interactive television coupled to the set-top box wherein the result of the performed data processing request is sent from the set-top box to the interactive television for display.

83. An apparatus to leverage external system resources, the apparatus comprising:
a. means for receiving a data processing request by a local device;
b. means for determining if a local processor includes a processing capability necessary to perform the data processing request;
c. means for transferring the data processing request to an external processor if the local processor is not capable of processing the data processing request;
d. means for performing the data processing request by the external processor; and
e. means for returning a result of the performed data processing request to the local device.

84. The apparatus of claim 83 wherein the necessary processing capability is determined by measuring a required time frame to complete the data processing request by the local processor and matching the required time frame to a predetermined processing time limit.

85. The apparatus of claim 83 wherein the data processing request is sent in response to a user selecting an application provided by the local device.

86. The apparatus of claim 83 wherein the data processing request is related to a processing intensive application.

87. The apparatus of claim 83 wherein the local device comprises a set-top box.

88. The apparatus of claim 87 wherein the external processor resides within a personal computer.

89. The apparatus of claim 88 wherein the set-top box is coupled to the personal computer via a home network.

90. The apparatus of claim 83 further comprising means for determining if the external processor is capable of processing the data processing request prior to transferring the data processing request to the external processor.

91. The apparatus of claim 83 wherein the data processing request includes a corresponding data to be processed.

92. The apparatus of claim 91 wherein the means for performing the data processing request comprises means for processing the corresponding data.

93. The apparatus of claim 83 wherein the corresponding data to be processed is transferred to the external processor from a remote content source.

94. The apparatus of claim 93 wherein the corresponding data to be processed is transferred to the external processor from the remote source via the local device.

95. The apparatus of claim 94 wherein the remote content source comprises a cable service provider, a satellite service provider, or a content source coupled to the internet.

96. The apparatus of claim 83 wherein the corresponding data to be processed is transferred to the external processor from a local storage device coupled to the external processor.

97. The apparatus of claim 83 wherein the local device and the external processor form a master-slave relationship such that the local device is the master and the external processor is the slave.
